(19) United States
(12) Patent Application Publication
(10) Pub. No.: US 2025/0229968 A1
(43) Pub. Date: Jul. 17, 2025

(54) Packing Material, Use, and Methods of Manufacture

(71) Applicant: Brandon D. Freeman, Columbus, IN (US)

(72) Inventor: Brandon D. Freeman, Columbus, IN (US)

(21) Appl. No.: 19/090,039

(22) Filed: Mar. 25, 2025

Related U.S. Application Data
(62) Division of application No. 17/573,058, filed on Jan. 11, 2022.
(60) Provisional application No. 63/135,820, filed on Jan. 11, 2021.

(51) Int. Cl. B65D 81/05; B31D 5/00

(52) U.S. Cl. CPC B65D 81/05; B31D 5/006; B31D 2205/0023; B31D 2205/0058

(57) ABSTRACT

A packing material, its use, method of manufacture, and method of production creates a curl or spiral having elastic, cushioning, form-fitting, and coherent packing properties. The curl is created from a dimension-controlled strip of cohesive paper having a cohesive side and a non-cohesive side, and formed with a leading end that is folded upon itself such that a cohesive side of the leading end contacts the cohesive side of the dimension controlled strip of cohesive paper, and a trailing end opposite the leading end that is folded upon itself such that a non-cohesive side of the trailing end contacts the non-cohesive side of the dimensioned strip of cohesive paper, wherein the dimensioned strip of cohesive paper is wound into a spiral with the cohesive side of the dimensioned strip of cohesive paper facing outward. A plurality of curls provides a clumped, cohesive mass around a packed item.

### CROSS-REFERENCE TO RELATED APPLICATIONS

This U.S. non-provisional patent application is a division of U.S. non-provisional patent application Ser. No. 17/573,058 filed Jan. 11, 2022 titled Packing Material, Use, and Methods of Manufacture which claims the benefit of and/or priority under 35 U.S.C. § 119 (e) to U.S. provisional patent application Ser. No. 63/135,820 filed Jan. 11, 2021 titled Packing Material and Method of Manufacture, the entire contents of each of which is specifically incorporated herein by reference.

### FIELD OF THE INVENTION

The present invention relates to packing materials for storing, shipping, and/or protecting packaged items and, more particularly, to sustainable packing material for storing, shipping, and/or protecting packaged items.

### BACKGROUND OF THE INVENTION

A significant number of goods are shipped throughout the United States every day. The growth of on-line purchasing has created a boon in shipping. However, merchandise damaged during transit creates lost revenue and frustration for the recipient. It is thus beneficial to the shipper, the merchant, and the recipient for the shipped goods to arrive undamaged. In order to try and ensure undamaged delivery, dunnage or packing material(s) are used to wrap or otherwise envelope the goods for shipping.

Heretofore, various types of packing material(s) have been used. Plastic peanuts, plastic balls and the like, plastic bubble-wrap, plastic air-filled “pillows,” form-fitting foam, and straw and straw-like material are used as packing material. All of these packing materials have drawbacks. Particularly, plastic is bad for the environment since it is not biodegradable. Because of this, paper packing material is preferable over plastic packing material since paper is biodegradable and easily recyclable. While single crumpled paper sheets are not practical for large-scale packaging, paper sheets, or simply paper, converted into a low density packing or cushioning product is practical.

Assorted patents have been granted for converting paper into a low density packing or cushioning product. For example, U.S. Pat. No. 6,626,813 discloses a cushioning conversion system and method for making a coil of cushioning product from a sheet of paper. FIG. 6 of U.S. Pat. No. 6,626,813 shows the produced coil of cushioning product (the '813 coil), the '813 coil having a width the size of the sheet of paper. The size of the '813 coil makes it impractical to form the coils into adequate packing material that can cushion around variously-shaped items without much manipulating of the '813 coil or cutting them. This adds an additional packing step. U.S. Patent Publication 2008/0153685 discloses a method of making a dunnage (packing) product from a continuous length of stock material having a cohesive on at least one surface. The dunnage product is a large coil of crumpled paper (the '685 coil) that uses its cohesiveness to keep its crumpled and coiled shape. Like the '813 coil, the '685 coil makes it impractical to form the coils into adequate packing material that can cushion around variously-shaped items without much manipulating of the '685 coil-adding an additional packing step. Moreover, the '813 and '685 coils are not able to form a generally cohesive packing mass around an item or items for packing, creating only a loose assemblage of coils that can shift and move during transit.

In view of the above, it would therefore be desirous to have a paper-based packing product that alleviates the shortcomings of the prior art. It would be further desirous to have a paper-based packing product formed by a curl or spiral of cohesive paper wherein the cohesive portion of the paper is on the outside of the curl/spiral (i.e., faces radially outward). It would therefore be even further desirous to have a paper-based packing product of individual curls/spirals that forms a generally cohesive mass about an item or items for packing. The present invention addresses the above issues.

### SUMMARY OF THE INVENTION

The present invention is a paper-based dunnage, packing, and/or cushioning product or the like (collectively, packing product), its use, methods of manufacture, and manufacturing machines. The packing product is fashioned as a curl or spiral (collectively, curl) from a dimension controlled, spiraled/wound strip of cohesive paper having a cohesive side and a non-cohesive side and formed with a leading end that is bent upon itself such that a cohesive side of the leading end contacts the cohesive side of the dimension controlled strip of cohesive paper, and a trailing end opposite the leading end that is bent upon itself such that a non-cohesive side of the trailing end contacts the non-cohesive side of the dimensioned strip of cohesive paper, wherein the dimensioned strip of cohesive paper is spiraled or wound into a curl or spiral with the cohesive side of the dimensioned strip of cohesive paper on the outside of the curl/spiral.

A plurality of the present curls provides a generally cohesive mass or clump around an item or items in packing due to the curls loosely adhering to one another. The curls may also loosely adhere to the item or items. A method of packing an item or items includes placing a plurality of the present packing curls into a package with the item or items. The method may include providing a plurality of curls dimensioned and sized according to the item or items being packed. Smaller items may use smaller curls while large items may use larger curls, or vice versa. A mix of curl sizes may be used.

In one form, a curl is formed from roll of cohesive paper that is dimensioned into a strip of cohesive paper having a width that is preferably, but not necessarily, one quarter inch (¼″) to three quarters inch (¾″), with one half inch (½″) being most preferable, and preferably, but not necessarily, two inches (2″) to six inches (6″) long. Other sizes are contemplated and may depend on the size of the item or items being packed. The cohesive paper has a weight that is preferably, but not necessarily, from the teens to the fifties. The width or vertical side of a curl provides blocking/stack strength for the packaged item, while the size of the curl (length or horizontal side) provides cushioning for the packaged item. When a plurality of curls are clumped together in random directions, a protectant mass is formed around an item or items by interaction of the cohesive nature of the cohesive paper of each curl with respect to other curls. A mass of curls can assume any size and shape, especially around a packaged item, such as in a corrugated box.

The curls can be used for single or multiple, light or heavy items. The curls may also be used in conjunction with an item or items wrapped in cohesive paper. With the cohesive side of the paper placed on the outside of the item or items, the curls surround the item or items to stabilize as well as protect the item(s). Such packing also keeps the item(s) free from abrasion. Other types of cohesive wrapping such as, but not limited to, foam may be used in place of cohesive paper wrapping.

The curl producing machine may be sized according to application need. For instance, a small desktop curl producing machine may be used for packing small boxes, while a larger, free-standing curl producing machine may be used for packing larger boxes. Curl producing machines may be fashioned for low volume curl production or high volume curl production.

A method and machine of producing a curl includes providing a roll of a cohesive paper sheet having a cohesive side and a non-cohesive side, cutting the cohesive paper sheet into a dimensioned strip, creating a folded leading end on the dimensioned strip that is bent upon itself such that a cohesive side of the leading end adheres to the cohesive side of the dimensioned strip of cohesive paper, creating a trailing end on the dimensioned strip opposite the leading end that is bent upon itself such that a non-cohesive side of the trailing end contacts the non-cohesive side of the dimensioned strip of cohesive paper, and winding/spiraling and cutting the dimensioned and end folded strip of cohesive paper into a curl or spiral with the cohesive side of the dimensioned and end folded strip of cohesive paper on the outside. Cutting of the strips may occur before winding, after winding, or in conjunction with winding.

A method of and machine for packing or cushioning one or more items includes providing a plurality of the present curls or spirals around or about the one or more items, with or without the item(s) first being swathed in a cohesive wrapper. The plurality of curls are preferably, but not necessarily, dimensioned and sized according to the item or items being packed. Smaller items may use smaller curls while large items may use larger curls, or vice versa. A mix of curl sizes may be used. The present machines for producing the curls are adjustable to provide different lengths of curls, width, etc. for different packing needs.

Different cohesive papers may be used for the curls. The cohesive paper may be have a color, be different weights, or have texturing.

Further aspects of the present invention will become apparent from consideration of the drawings and the following description of forms of the present invention. A person skilled in the art will realize that other forms of the invention are possible and that the details of the invention can be modified in a number of respects without departing from the inventive concept. The following drawings and description are to be regarded as illustrative in nature and not restrictive.

### BRIEF DESCRIPTION OF THE FIGURES

The present invention and its features will be better understood by reference to the accompanying illustrations/drawings, wherein:

FIG. 1 is diagrammatic view of an exemplary machine for producing packing curls (curls) from a supply of cohesive paper in accordance with the principles of the present invention;

FIG. 2 is a view of an individual packing curl that can be made by the machine of FIG. 1 and a method of manufacture as described herein;

FIG. 3 is a view of a packaged item surrounded by a mass (plurality) of packing curls (curls) made by the exemplary machine of FIG. 1, the mass of packing curls creating a void filler that cushions and protects the packaged item;

FIG. 4 is a view of a roll of cohesive paper used for the present packing curls;

FIG. 5 is a schematic view of another exemplary machine for producing packing curls (curls) from a supply of cohesive paper in accordance with the principles of the present invention;

FIG. 6 is a side view of an exemplary cut and folded strip of cohesive paper ready for curling;

FIGS. 7A-E depict a sequence of curling of the exemplary cut and folded strip of cohesive paper of FIG. 6 into a packing curl in accordance with the principles of the present invention;

FIG. 8 is a perspective view of a packing curl produced by the principles of the present invention;

FIG. 9 is a diagrammatic view of the exemplary folding section of the exemplary machine of FIG. 5;

FIG. 10 is an enlarged view illustrating the flow of cohesive paper through the exemplary folding section of FIG. 9; and

FIG. 11 is a top view of an exemplary roller for curling and cutting the curls.

For the purposes of promoting an understanding of the principles of this invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

### DETAILED DESCRIPTION OF THE INVENTION

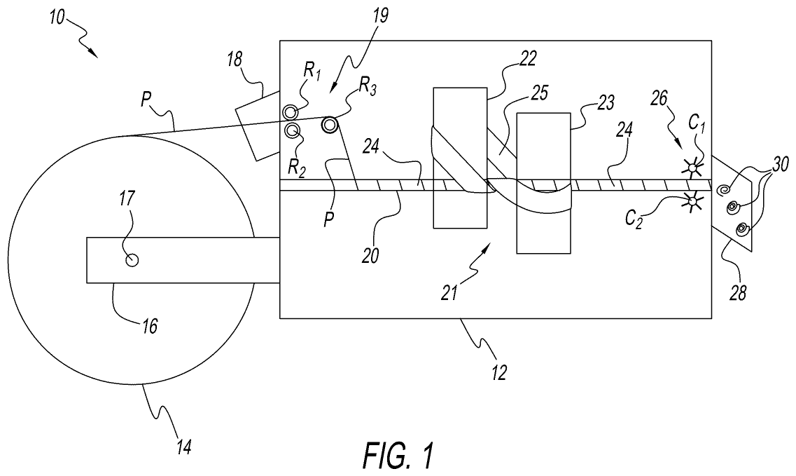

Referring to FIG. 1, there is shown a diagrammatic view of an exemplary machine, mechanism, apparatus or the like (collectively, machine) 10 for producing one form of curls 30 in accordance with the present principles. It should be understood that the machine 10 of FIG. 1 depicts only basic components and/or features for producing the curls 30. The machine 10 has a housing 12 to which is connected a paper holder 16. A roll of cohesive paper 14 (cohesive paper being paper with a cohesive on one side only) is held by the paper holder 16 such that the roll of cohesive paper 14 may freely rotate about an axle 17 of the paper holder 16. The paper holder 16 is configured to allow various sizes (length and width) of rolls of cohesive paper to be retained. The paper holder 16 is also configured to allow replacement of cohesive paper rolls.

Cohesive paper (a continuous cohesive paper sheet), collectively cohesive paper P, from the cohesive paper roll 14 is received by/into a paper feed/feeder/feed mechanism (collectively, feed) 18 which directs the cohesive paper P into the housing 12 and to a paper guide 19. The paper guide 19 includes first and second feed rollers R1, R2 disposed opposite one another such that the cohesive paper P is properly received and aligned for curling and cutting. The first and second rollers R1, R2 lead the cohesive paper P over a third roller R3 such that the cohesive paper P is received onto a shaft 20. A rotation mechanism 21, here shown as a first motive roller 22 and a second motive roller 23 connected by a belt or belt drive 25, rotates the shaft 20 and cohesive paper to provide wound cohesive paper 24 about the shaft 20.

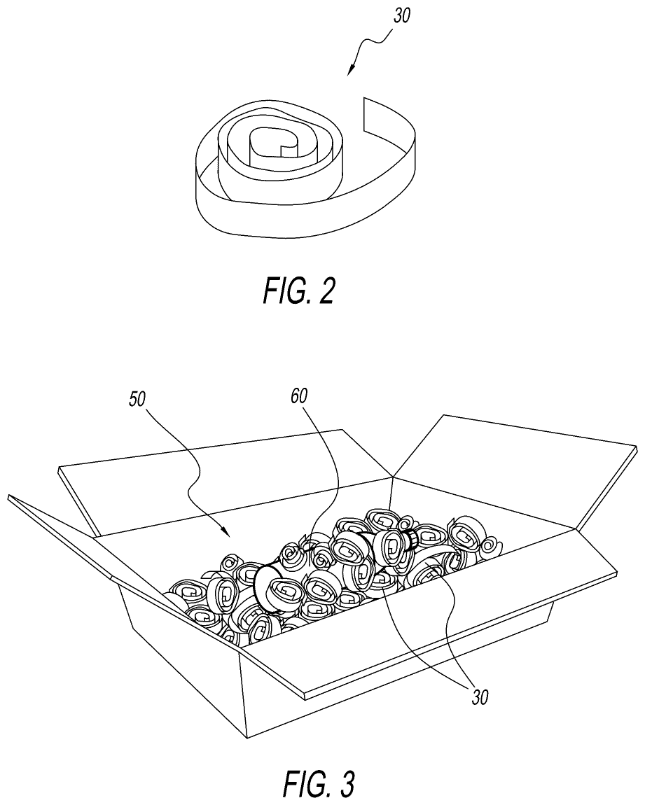

The wound cohesive paper 24 travels about the shaft 20 where it encounters a cutter 26, here shown as two cutting blades C1 and C2, that cuts the wound cohesive paper 24 into cohesive paper packing curls (curls) 30, one of which is shown in FIG. 2. Preferably, but not necessarily, each curl has a width of one quarter inch (¼″) to three quarters inch (¾″) with one half inch (½″) being most preferable, and a length of two inches (2″) to six inches (6″) long. The curls 30 are released into a director 28 which dispenses the curls 30 into a hopper (not shown) or directly into a box as shown in FIG. 3 which contains an item 60. FIG. 3 shows a mass 50 of curls 30 about and/or around the item 60 for product/item packing, cushioning, blocking, bracing, and/or void fill.

While the machine 10 cuts the wound cohesive paper 24 into curls 30 after winding on the shaft 24, it should be appreciated that a machine may produce the present curls by first cutting the cohesive paper into the desired size (width and length) of strips before curling. Moreover, the roll of cohesive paper may already have a width of one quarter inch (¼″) to three quarters inch (¾″), which is then cut to a length of two inches (2″) to six inches (6″) long for curling.

Variations in the curl producing machine 10 are contemplated such as, but not limited to, placement and numbers of cohesive paper guide/feed rollers, the manner of rotating the curling shaft, the manner of feeding the cohesive paper into the curling and cutting mechanisms, and the like. Other variations are contemplated, the end result of which is to make/produce curls 30.

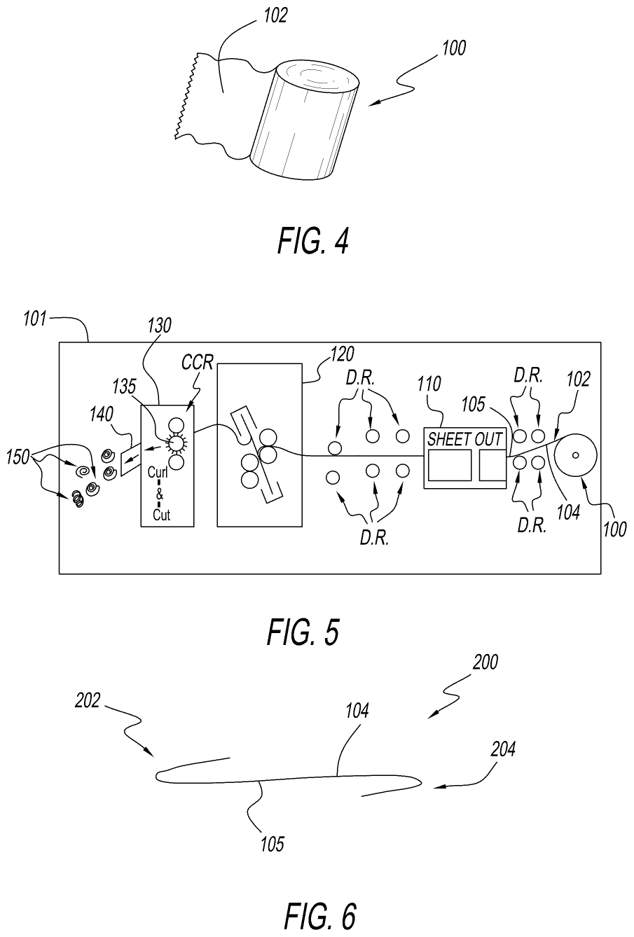

Referring now to FIG. 4, there is depicted an illustrative roll of cohesive paper 100 such as can be used in the curl producing machine 10 of FIG. 1 and the exemplary curl producing machine 101 of FIG. 5 that produces curls 150 from cut and end-folded strips 200 (see, e.g., FIG. 6) of cohesive paper. The roll of cohesive paper 100 is formed by a wound continuous sheet 102 of cohesive paper of a given width. The machine 101 can accommodate rolls of various widths. As shown in FIG. 5, the sheet of cohesive paper 102 has a cohesive side 104 and a non-cohesive side 105. The exemplary curl producing machine 101 feeds the sheet of cohesive paper 102 through various drive rollers (D.R.) to a cutter or cutting section 110 (labeled Sheet Cut in FIG. 5). The cutting section 110 cuts the sheet of cohesive paper 102 into individual sheets of a given length, the given length of which will be (is) the total length of a curl 150. The cutting section 110 is configured to adjust length size of each individual sheet. Same length individual sheets may be produced in succession or variations in individual sheet length.

The individual length-cut sheets are conveyed to a folder or folding section 120 via drive rollers (D.R.). The folding section 120 is designed to create a folded leading end or edge 202 and a folded trailing end or edge 204 opposite to the folded leading end 202 to each individual length-cut sheet of cohesive paper 200 (see, e.g., FIG. 6). The leading end 202 is folded back onto itself such that the cohesive side 104 of the folded leading end 202 contacts and adheres to the cohesive side 104 of the sheet of cohesive paper 200, while the trailing end 204 is folded back onto itself such that the non-cohesive side 105 of the folded trailing end 204 contacts to the non-cohesive side 105 of the sheet of cohesive paper 200. An individual end folded length of cohesive sheet 200 is depicted in FIG. 6. At this point, the sheet 200 is ready to be cut and curled, although not necessarily in that order. Cutting and curling can also be performed simultaneously such as with a cutting/curling roller 320 of FIG. 11.

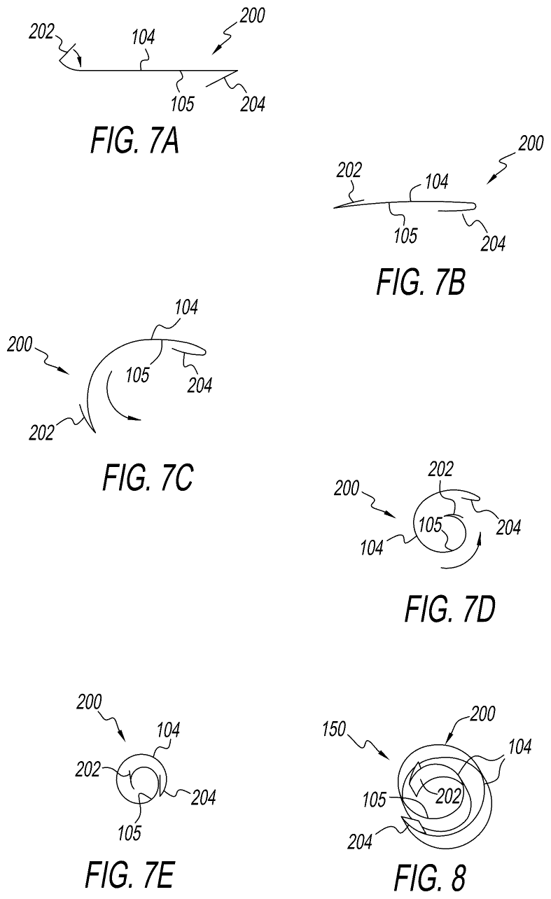

In FIGS. 7A-7E, the formation of a curl 150 is illustrated. It should be appreciated that this illustration does not show the mechanism (e.g. rollers, cutters, etc.) for curling, but rather illustrates the manner in which the sheet of cohesive paper 200 is curled. In FIG. 7A the individual sheet of cohesive paper 200 is shown before its ends/edges have been folded. In FIG. 7B, the leading end/edge 202 has been folded such that its cohesive side adheres to the cohesive side 104 of the sheet of cohesive paper 200, while the trailing end/edge 204 of the sheet of cohesive paper 200 has been folded such that its non-cohesive side abuts the non-cohesive side 105 of the sheet of cohesive paper 200. In FIG. 7C, the end-folded sheet of cohesive paper 200 is beginning to be coiled, wound, spiraled, twisted, curled, or the like into a curl 150. The leading end 202 is being curled under itself such that the cohesive side 104 faces outward (is radially outward with respect to the curl 150) and the non-cohesive side 105 faces inward (is radially inward with respect to the curl 150). FIG. 7D illustrates further curling of the end-folded sheet of cohesive paper 200 from that of FIG. 7C. FIG. 7E illustrates a final or near final curling of the sheet of cohesive paper 200. FIG. 8 depicts a final curl 150 cut in a desired strip width. It should be appreciated that the end-folded strip of cohesive paper 200 may be wound or spiraled opposite, or differently, to that shown in FIGS. 7A-E while achieving the same result of having the cohesive side of the curls 150 facing outward.

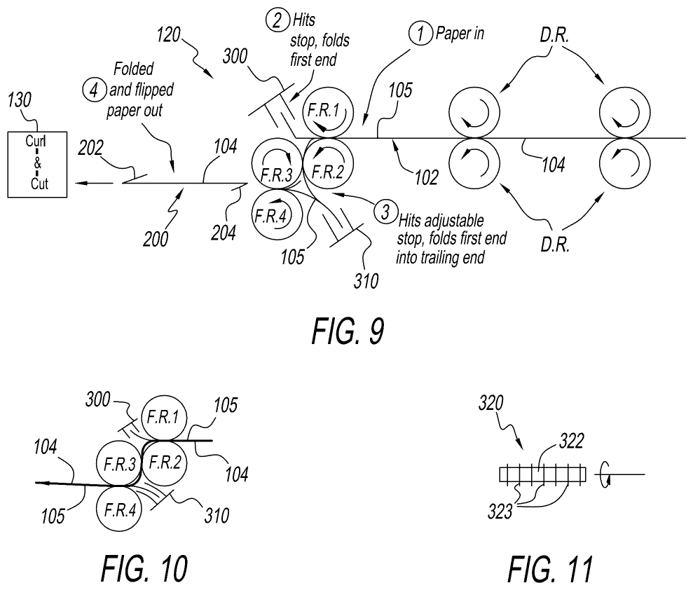

FIGS. 9 and 10 provide a more detailed depiction of a manner in which the length-cut sheets of cohesive paper gets folded. Drive rollers direct or feed the length-cut sheets of cohesive paper into the folder. Initially, the nomenclature first and second are arbitrary and interchangeable here and throughout. A first end of the sheet 200 is directed by meshing of folding roller 1 (FR1) and folding roller 2 (FR2) into a first stop 300 which bends the first end onto itself such that the non-cohesive side 105 of the first end is adjacent to the non-cohesive side 105 of the sheet 200. As the first end is folded by the first stop 300, a crease is formed in the sheet 200, the crease of which is then fed/conveyed into meshing folding roller 2 (FR2) and folding roller 3 (FR3). The crease of the sheet 200 then becomes the crease of a folded trailing end 204. The folded trailing end 204 is fed into a second stop 310. The second end of the sheet 200 that is now opposite the trailing end 204 will be folded upon itself by meshing folding roller 3 (FR3) and folding roller 4 (FR4) when the trailing end 204 bottoms out in the second stop 310 to form a folded leading end 202. The leading end is folded such that a cohesive side of the second end contacts and adheres to the cohesive side 104 of the sheet 200. The length of the second stop 310 is adjustable. Direction of sheet travel is depicted in FIG. 10. The cohesive paper is fed into the machine 101 with the cohesive side in one direction, with the folded sheets of cohesive paper flipped for cutting. The end-folded sheet of cohesive paper 200 is then sent to the curler and cutter 130.

FIG. 11 depicts an exemplary curling and cutting roller 320 of the curl and cut section 130. A curling and cutting roller 320 is characterized by a cylinder 322 having a plurality of radial blades 323 spaced to provide a given strip width. Different rollers can provide a difference strip width. The curling and cutting section 130 may use more cutting rollers, and/or different manners of curling and cutting the sheets 200. The process of selecting strip width may also be automatic. As the sheets 200 are wound onto the roller 322, the blades 323 cut the width. Other manners may be used.

While the invention has been illustrated and described in detail in the drawings and foregoing description, the same is to be considered as illustrative and not restrictive in character, it being understood that only a preferred embodiment has been shown and described, and that all changes and modifications that come within the spirit of the invention are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention.

What is claimed is:

1. A packing product comprising:
a curl formed of a strip of cohesive paper having a first end, a second end opposite the first end, a cohesive side extending from the first end to the second end, and a non-cohesive side opposite the cohesive side and extending from the first end to the second end, the curl wound into a spiral of at least one 360° wind with the cohesive side of the strip of cohesive paper facing radially outward;
a leading fold formed at the first end of the strip of cohesive paper and creased such that the cohesive side of the leading fold abuts the cohesive side of the strip of cohesive paper; and
a trailing fold at the second end of the strip of cohesive paper and creased such that the non-cohesive side of the trailing fold abuts the non-cohesive side of the strip of cohesive paper.

2. The packing product of claim 1, wherein the curl is wound into a spiral of a plurality of 360° winds with the cohesive side of the strip of cohesive paper facing radially outward.

3. The packing product of claim 2, wherein the strip of cohesive paper has a width that is from one quarter inch (¼″) to three quarters inch (¾″), and a length of from two inches (2″) to six inches (6″).

4. The packing product of claim 3, wherein the width of the strip of cohesive paper is one half inch (½″).

5. A method of producing a packing product comprising:
providing a roll of a continuous sheet of cohesive paper having a cohesive side and a non-cohesive side;
cutting the continuous sheet of cohesive paper into a strip having a first end and a second end opposite the first end;
folding the first end of the strip of cohesive paper into a trailing end with the non-cohesive side of the trailing end abutting the non-cohesive side of the strip of cohesive paper;
folding the second end of the strip of cohesive paper into a leading end with the cohesive side of the strip of cohesive paper abutting and adhering to the cohesive side of the strip of cohesive paper; and
winding the strip of cohesive paper with its folded first and second ends into a spiral of at least one 360° wind with the cohesive side of the strip of cohesive paper facing radially outward, thereby forming a curl.

6. The method of claim 5, wherein the strip of cohesive paper is wound into a spiral of a plurality of 360° winds with the cohesive side of the strip of cohesive paper facing radially outward, thereby forming a curl.

7. The method of claim 6, wherein the strip of cohesive paper has a width from one quarter inch (¼″) to three quarters inch (¾″) and a length from two inches (2″) to six inches (6″).

8. The method of claim 7, wherein the strip of cohesive paper has a width of one half inch (½″).

9. A machine for producing packing product comprising:
a cohesive paper receiver configured to receive a continuous sheet of cohesive paper from a roll of a continuous sheet of cohesive paper having a cohesive side and a non-cohesive side;
a cutting section configured to receive the continuous sheet of cohesive paper from the cohesive paper receiver and to cut the continuous sheet of cohesive paper into a strip of cohesive paper having a first end, a second end opposite the first end, a width, and a length;
a folding section configured to receive the strip of cohesive paper from the cutting section and to fold the first end of the strip of cohesive paper into a trailing end with the non-cohesive side of the trailing end abutting the non-cohesive side of the strip of cohesive paper, and to fold the second end of the strip of cohesive paper into a leading end with a cohesive side of the strip of cohesive paper abutting and adhering to the cohesive side of the strip of cohesive paper;
a curling section configured to receive the ends-folded strip of cohesive paper from the folding section and wind the ends-folded strip of cohesive paper into a spiral of at least one 360° wind with its cohesive side facing radially outward, thereby forming a curl; and
an ejection section in communication with the curling section and configured to expel the curl from the machine.

10. The method of claim 9, wherein the strip of cohesive paper is wound into a spiral of a plurality of 360° winds with the cohesive side of the strip of cohesive paper facing radially outward, thereby forming a curl.

11. The machine of claim 10, wherein the strip of cohesive paper has a width from one quarter inch (¼″) to three quarters inch (¾″) and a length from two inches (2″) to six inches (6″).

12. The machine of claim 11, wherein strip of cohesive paper has a width of one half inch (½″).
